(19) United States
(12) Patent Application Publication
(10) Pub. No.: US 2025/0301000 A1
(43) Pub. Date: Sep. 25, 2025

(54) DATA PROCESSING APPARATUS, DATA PROCESSING METHOD, AND COMPUTER READABLE MEDIUM

(71) Applicant: Mitsubishi Electric Corporation, Tokyo (JP)

(72) Inventor: Teruyoshi YAMAGUCHI, Tokyo (JP)

(73) Assignee: Mitsubishi Electric Corporation, Tokyo (JP)

(21) Appl. No.: 19/230,573

(22) Filed: Jun. 6, 2025

Related U.S. Application Data
(63) Continuation of application No. PCT/JP2023/001858, filed on Jan. 23, 2023.

(51) Int. Cl. H04L 9/40; G06N 20/00

(52) U.S. Cl. CPC H04L 63/1416; G06N 20/00

(57) ABSTRACT

In a learning phase, a communication unit (203) acquires communication data that includes a parameter value from which an operation state of a monitored system can be estimated, and that is to be communicated in the monitored system, as learning phase communication data. In the learning phase, a state input unit (204) acquires a learning phase operation state value that indicates a learning phase operation state which is an operation state of the monitored system. In the learning phase, a learning unit (210) performs learning using the learning phase operation state value and a learning phase parameter value included in the learning phase communication data, and generates a learning model (215) for estimating from an attack detection phase parameter value included in attack detection phase communication data which is communication data that is to be communicated in the monitored system in the attack detection phase, an attack detection phase operation state which is an operation state of the monitored system.

### CROSS REFERENCE TO RELATED APPLICATION

This application is a Continuation of PCT International Application No. PCT/JP2023/001858, filed on Jan. 23, 2023, which is hereby expressly incorporated by reference into the present application.

### TECHNICAL FIELD

The present disclosure relates to technology for detecting attacks on a monitored system.

### BACKGROUND ART

In recent years, there has been an increase in cases where information systems become targets of cyber attacks. As a technology to detect such cyber attacks, there is the technology of Patent Literature 1.

In the technology of Patent Literature 1, attack detection is performed considering the operation state of the monitored system.

### CITATION LIST

### Patent Literature

Patent Literature 1: Patent No. JP 6054010 B2

### SUMMARY OF INVENTION

### Technical Problem

In the technology of Patent Literature 1, it is necessary for the user to input the current operation state of the monitored system.

It is difficult for the user to determine the current operation state of the monitored system. Therefore, if the user incorrectly recognizes the operation state of the monitored system, there is a problem that attacks on the monitored system cannot be correctly detected.

One of the main objectives of the present disclosure is to solve the above-mentioned problem. More specifically, the main objective of the present disclosure is to enable the correct estimation of the operation state of the monitored system, thereby enabling the correct detection of attacks on the monitored system.

### Solution to Problem

A data processing apparatus according to the present disclosure includes:
a communication data acquisition unit, in a learning phase prior to an attack detection phase, to acquire communication data that includes a parameter value from which an operation state of a monitored system can be estimated, and that is to be communicated in the monitored system being monitored for attack detection in the attack detection phase, as learning phase communication data;
a learning phase operation state value acquisition unit, in the learning phase, to acquire a learning phase operation state value that indicates a learning phase operation state which is an operation state of the monitored system at a time of communication of the learning phase communication data; and
a model generation unit, in the learning phase, to perform learning using the learning phase operation state value and a learning phase parameter value which is a parameter value included in the learning phase communication data, and to generate a state estimation model for estimating from an attack detection phase parameter value which is a parameter value included in attack detection phase communication data which is communication data that is to be communicated in the monitored system in the attack detection phase, an attack detection phase operation state which is an operation state of the monitored system at a time of communication of the attack detection phase communication data.

### Advantageous Effects of Invention

According to the present disclosure, it is possible to correctly estimate the operation state of the monitored system, and as a result, it is possible to correctly detect an attack on the monitored system.

### BRIEF DESCRIPTION OF DRAWINGS

FIG. 1 is a diagram illustrating an example of an overall configuration according to Embodiment 1.

FIG. 2 is a diagram illustrating an example of a hardware configuration of an intrusion detection apparatus according to Embodiment 1.

FIG. 3 is a diagram illustrating an example of a functional configuration of the intrusion detection apparatus according to Embodiment 1.

FIG. 4 is a diagram illustrating an overview of operation of the intrusion detection apparatus in a learning phase according to Embodiment 1.

FIG. 5 is a diagram illustrating an overview of operation of the intrusion detection apparatus in an attack detection phase according to Embodiment 1.

FIG. 6 is a flowchart illustrating an example of operation of a communication data analysis unit according to Embodiment 1.

FIG. 7 is a diagram illustrating an example of process values according to Embodiment 1.

FIG. 8 is a flowchart illustrating an example of operation of a process value table update unit according to Embodiment 1.

FIG. 9 is a diagram illustrating an example of a process value table according to Embodiment 1.

FIG. 10 is a flowchart illustrating an example of operation of a learning unit according to Embodiment 1.

FIG. 11 is a diagram illustrating an overview of a learning procedure according to Embodiment 1.

FIG. 12 is a flowchart illustrating an example of operation of a detection rule generation unit according to Embodiment 1.

FIG. 13 is a diagram illustrating an example of a detection rule according to Embodiment 1.

FIG. 14 is a flowchart illustrating an example of operation of a state estimation unit according to Embodiment 1.

FIG. 15 is a diagram illustrating an overview of a state estimation procedure according to Embodiment 1.

FIG. 16 is a flowchart illustrating an example of operation of an attack detection unit according to Embodiment 1.

FIG. 17 is a diagram illustrating an example of functional configuration of the intrusion detection apparatus according to Embodiment 2.

FIG. 18 is a diagram illustrating an overview of operation of the intrusion detection apparatus in the learning phase according to Embodiment 2.

FIG. 19 is a flowchart illustrating an example of operation of a learning determination unit according to Embodiment 2.

### DESCRIPTION OF EMBODIMENTS

Embodiments will be described hereinafter with reference to the drawings. In the following description of the embodiments and the drawings, portions denoted by the same reference signs indicate the same or corresponding portions.

### Embodiment 1

### ***Description of Configuration***

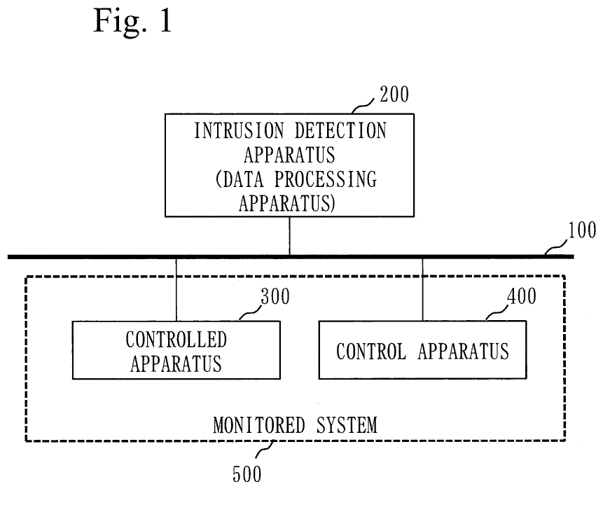

FIG. 1 illustrates an overall configuration according to the present embodiment.

In the present embodiment, as illustrated in FIG. 1, an intrusion detection apparatus 200, a controlled apparatus 300, and a control apparatus 400 are connected via a network 100.

The controlled apparatus 300 and the control apparatus 400 communicate communication data (e.g., communication packets) with each other.

In FIG. 1, one controlled apparatus 300 and one control apparatus 400 are illustrated, but there may be two or more controlled apparatuses 300 and control apparatuses 400.

The controlled apparatus 300 and the control apparatus 400 correspond to a monitored system 500, which is subject to monitoring by the intrusion detection apparatus 200. When there is no need to distinguish between the controlled apparatus 300 and the control apparatus 400, they are collectively referred to as the monitored system 500.

The intrusion detection apparatus 200 monitors the monitored system 500 for attack detection. Further, the intrusion detection apparatus 200 performs machine learning (hereinafter, simply referred to as learning) for estimating an operation state of the monitored system 500.

The intrusion detection apparatus 200 acquires communication data that is to be communicated between the controlled apparatus 300 and the control apparatus 400 for learning and attack detection.

For example, the intrusion detection apparatus 200 is connected to the mirror port of a switching hub (not illustrated) on the network 100.

The communication data that is to be communicated between the controlled apparatus 300 and the control apparatus 400 includes a parameter value from which the operation state of the monitored system 500 can be estimated.

The intrusion detection apparatus 200 is equivalent to a data processing apparatus. An operation procedure of the intrusion detection apparatus 200 is equivalent to a data processing method. Further, a program that implements operation of the intrusion detection apparatus 200 is equivalent to a data processing program.

Before describing the details of a configuration example of the intrusion detection apparatus 200, an overview of the operation of the intrusion detection apparatus 200 will be described.

The operation phase of the intrusion detection apparatus 200 is broadly divided into a learning phase and an attack detection phase.

The learning phase is conducted prior to the attack detection phase. In the learning phase, machine learning is performed. In the attack detection phase, attacks on the monitored system 500 are detected using results of machine learning.

Below, an overview of the operation of the intrusion detection apparatus 200 in the learning phase and the attack detection phase will be described.

In the learning phase, the intrusion detection apparatus 200 acquires communication data communicated between the controlled apparatus 300 and the control apparatus 400 for learning. The communication data acquired by the intrusion detection apparatus 200 in the learning phase is referred to as learning phase communication data.

Additionally, the intrusion detection apparatus 200 acquires values indicating operation state of the monitored system 500 at the time of communication of the learning phase communication data from a user of the intrusion detection apparatus 200. The operation state of the monitored system 500 at the time of communication of the learning phase communication data is referred to as a learning phase operation state. Furthermore, a value indicating the learning phase operation state is referred to as a learning phase operation state value.

The intrusion detection apparatus 200 acquires, for example, a value indicating one of stop, startup, operation, shutdown, maintenance, etc., as the learning phase operation state value through user input.

Further, the intrusion detection apparatus 200 performs machine learning using a learning phase parameter value and the learning phase operation state value. The learning phase parameter value is a parameter value included in the learning phase communication data.

Then, the intrusion detection apparatus 200 generates a learning model which is a state estimation model as a result of the machine learning.

The learning model is a model for estimating from an attack detection phase parameter value, the operation state of the monitored system 500 at the time of communication of attack detection phase communication data. The attack detection phase communication data is communication data that is to be communicated in the monitored system 500 in the attack detection phase. The attack detection phase parameter value is a parameter value included in the attack detection phase communication data.

The operation state of the monitored system 500 at the time of communication of attack detection phase communication data is referred to as an attack detection phase operation state.

Further, in the learning phase, the intrusion detection apparatus 200 generates a detection rule for detecting an attack on the monitored system 500 in the attack detection phase.

In the attack detection phase, the intrusion detection apparatus 200 acquires communication data (attack detection phase communication data) communicated in the monitored system 500.

Further, the intrusion detection apparatus 200 estimates the attack detection phase operation state using the attack detection phase parameter value and the learning model.

Furthermore, the intrusion detection apparatus 200 detects an attack on the monitored system 500 using the detection rule and the communication data (attack detection phase communication data).

Next, an example of a configuration of the intrusion detection apparatus 200 will be described.

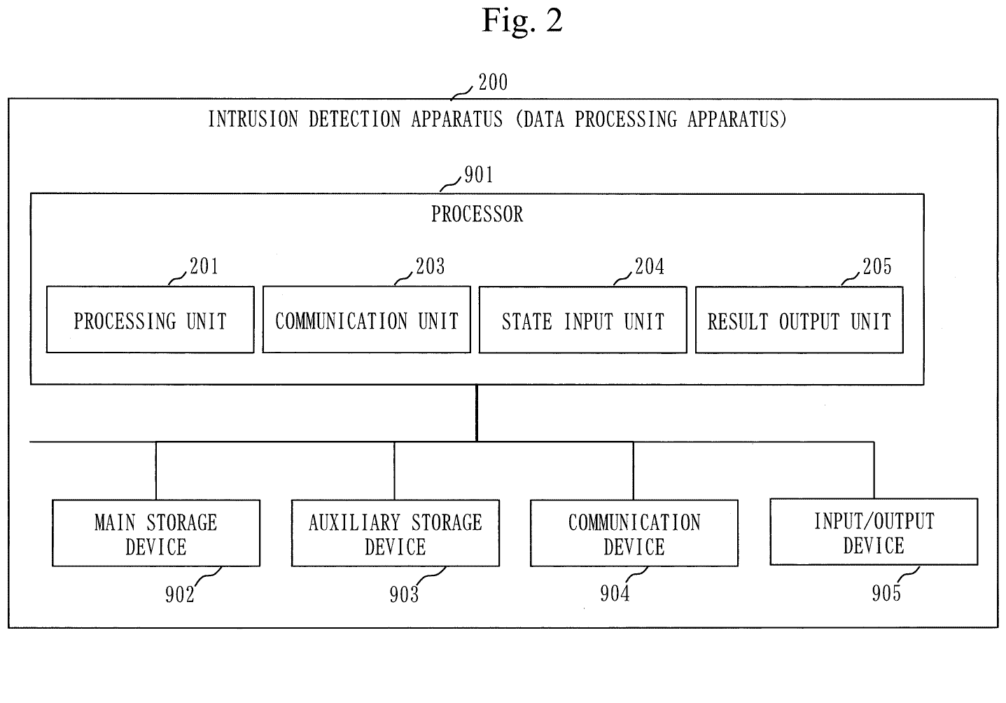

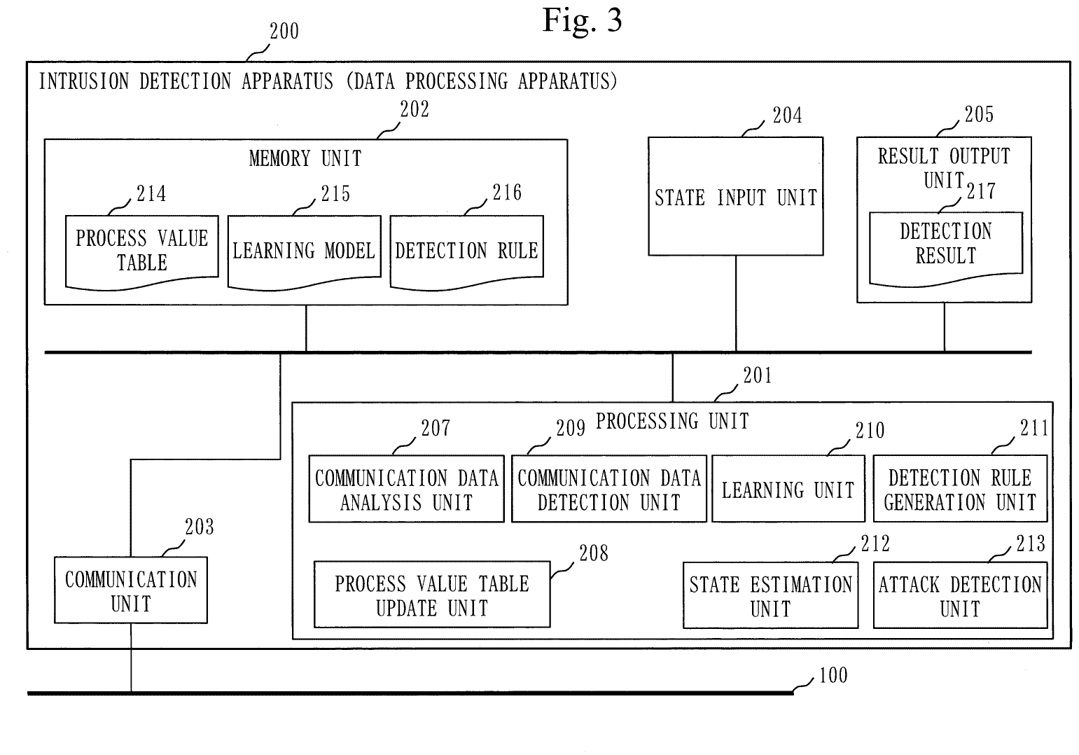

FIG. 2 illustrates an example of a hardware configuration of the intrusion detection apparatus 200. FIG. 3 illustrates an example of a functional configuration of the intrusion detection apparatus 200.

First, the example of the hardware configuration of the intrusion detection apparatus 200 will be described with reference to FIG. 2.

The intrusion detection apparatus 200 is a computer.

The intrusion detection apparatus 200 includes a processor 901, a main storage device 902, an auxiliary storage device 903, a communication device 904, and an input/output device 905, as pieces of hardware.

Further, the intrusion detection apparatus 200 includes, as illustrated in FIG. 3, a processing unit 201, a memory unit 202, a communication unit 203, a state input unit 204, and a result output unit 205, as functional components. The functions of the processing unit 201, the communication unit 203, the state input unit 204, and the result output unit 205 are implemented by, for example, programs.

The auxiliary storage device 903 stores programs that implement the functions of the processing unit 201, the communication unit 203, the state input unit 204, and the result output unit 205.

These programs are loaded from the auxiliary storage device 903 to the main storage device 902. Then, the processor 901 executes these programs, and performs operation of the processing unit 201, the communication unit 203, the state input unit 204, and the result output unit 205, to be described below.

FIG. 2 schematically illustrates a state in which the processor 901 executes the programs that implement the functions of the processing unit 201, the communication unit 203, the state input unit 204, and the result output unit 205.

The memory unit 202 illustrated in FIG. 3 is implemented by, for example, the main storage device 902 and/or the auxiliary storage device 903.

The input/output device 905 is a mouse, a keyboard, a camera, a display, a speaker, or the like.

In FIG. 3, the processing unit 201 is configured with a communication data analysis unit 207, a process value table update unit 208, a communication data detection unit 209, a learning unit 210, a detection rule generation unit 211, a state estimation unit 212, and an attack detection unit 213.

The details of each of the communication data analysis unit 207, the process value table update unit 208, the communication data detection unit 209, the learning unit 210, the detection rule generation unit 211, the state estimation unit 212, and the attack detection unit 213 will be described below.

The memory unit 202 stores a process value table 214, a learning model 215, and a detection rule 216.

The process value table 214 is a table for managing a process value. The process value is a parameter value included in communication data. The process value is a parameter value from which the operation state of the monitored system 500 can be estimated.

In the process value table 214, the process value is managed in each of the learning phase and the attack detection phase. The process value managed in the process value table 214 in the learning phase is equivalent to the learning phase parameter value. On the other hand, the process value managed in the process value table 214 in the attack detection phase is equivalent to the attack detection phase parameter value.

The learning model 215 is a state estimation model for estimating the operation state of the monitored system 500 in the attack detection phase.

The detection rule 216 is a rule for detecting an attack on the monitored system 500 in the attack detection phase.

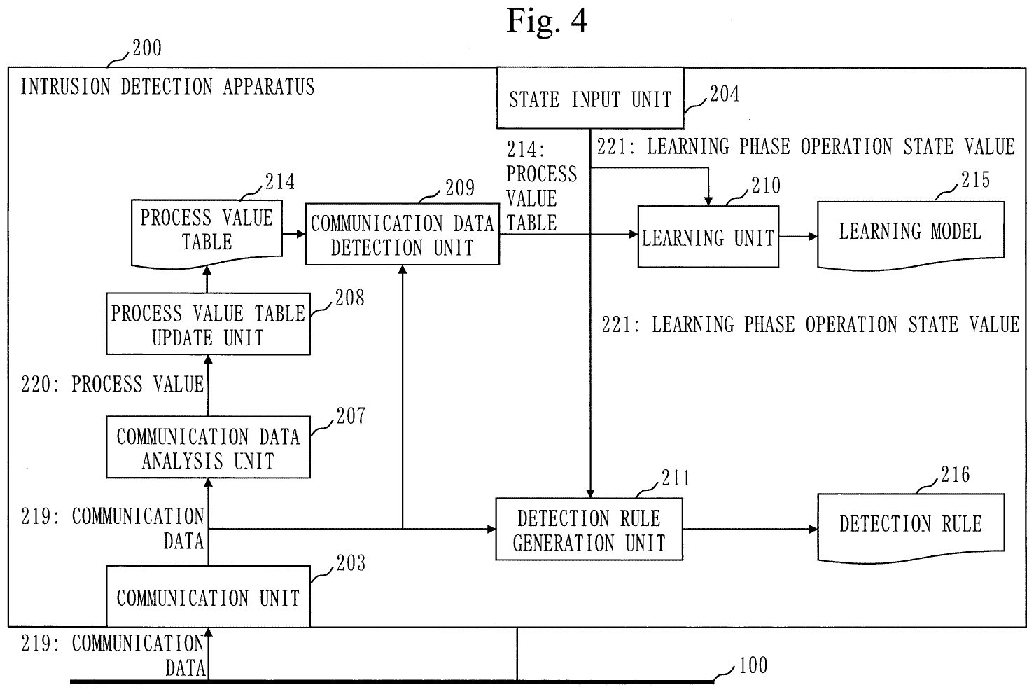

FIG. 4 illustrates an overview of operation of the communication unit 203, the state input unit 204, the communication data analysis unit 207, the process value table update unit 208, the communication data detection unit 209, the learning unit 210, and the detection rule generation unit 211, in the learning phase.

The communication unit 203 uses the communication device 904 to acquire the communication data 219 (learning phase communication data) communicated in the monitored system 500 from the network 100. The communication unit 203 repeatedly acquires the communication data 219. Then, each time the communication unit 203 acquires the communication data 219, the communication unit 203 outputs the acquired communication data 219 to the communication data analysis unit 207, the communication data detection unit 209, and the detection rule generation unit 211.

The communication unit 203 is equivalent to a communication data acquisition unit according to the present disclosure. Further, a process performed by the communication unit 203 is equivalent to a communication data acquisition process according to the present disclosure.

When the communication unit 203 acquires communication data, the state input unit 204 acquires a learning phase operation state value 221 from the user of the intrusion detection apparatus 200 via the input/output device 905.

The state input unit 204 is equivalent to a learning phase operation state value acquisition unit according to the present disclosure. Further, a process performed by the state input unit 204 is equivalent to a learning phase operation state value acquisition process according to the present disclosure.

The communication data analysis unit 207 analyzes the communication data 219. Then, the communication data analysis unit 207 extracts a process value 220 from the communication data 219.

In other words, the communication data analysis unit 207 extracts the process value 220 from the communication data 219 as the learning phase parameter value.

The process value table update unit 208 updates the process value table 214.

In other words, each time the communication data analysis unit 207 extracts the process value 220, the process value table update unit 208 updates the process value table 214 with the extracted process value 220.

The communication data detection unit 209 detects that the communication data 219 (learning phase communication data) is acquired by the communication unit 203. Then, the communication data detection unit 209 outputs the process value table 214 to the learning unit 210 and instructs the learning unit 210 to proceed with learning.

The learning unit 210 performs the learning using the learning phase operation state value 221 and the process value 220 included in the process value table 214. The process value 220 included in the process value table 214 is the learning phase parameter value.

Then, the learning unit 210 generates the learning model 215 as a result of the learning.

The learning unit 210 uses, for example, a learning method such as a support vector machine or a neural network.

The learning unit 210 is equivalent to a model generation unit according to the present disclosure. Further, a process performed by the learning unit 210 is equivalent to a model generation process according to the present disclosure.

The detection rule generation unit 211 generates the detection rule 216 using the communication data 219 and the learning phase operation state value 221.

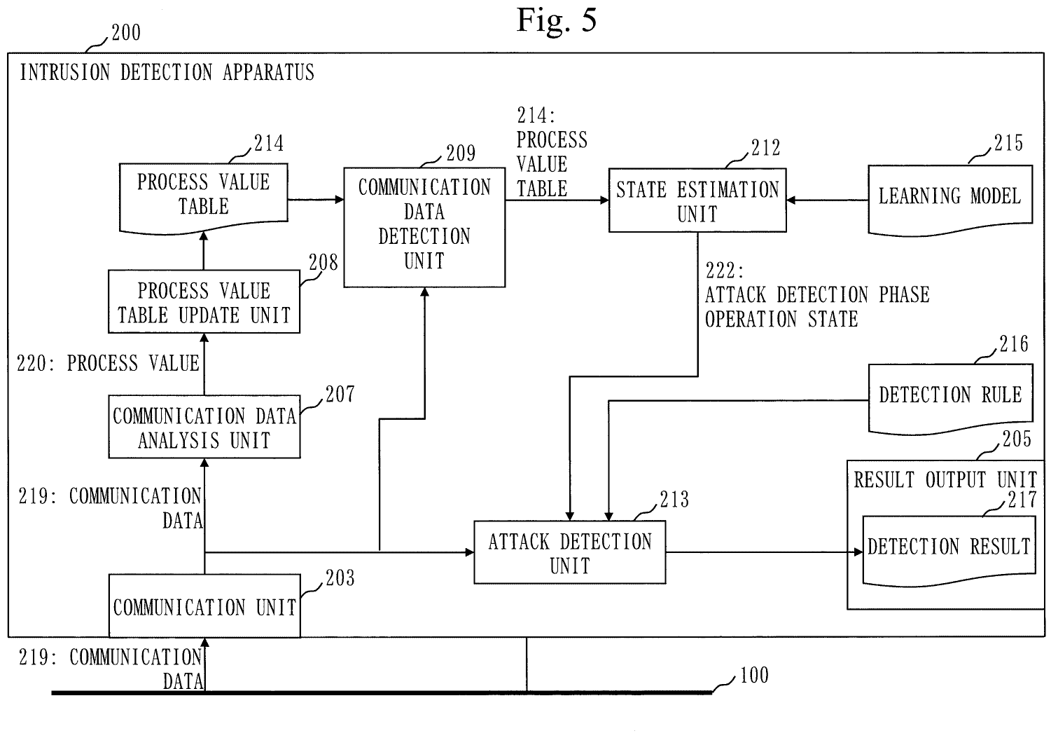

FIG. 5 illustrates an overview of operation of the communication unit 203, the result output unit 205, the communication data analysis unit 207, the process value table update unit 208, the communication data detection unit 209, the state estimation unit 212, and the attack detection unit 213, in the attack detection phase.

The communication unit 203 acquires the communication data 219 (attack detection phase communication data) communicated in the monitored system 500 from the network 100.

The communication data analysis unit 207 analyses the communication data 219. Then, the communication data analysis unit 207 extracts the process value 220 from the communication data 219.

In other words, the communication data analysis unit 207 extracts the process value 220 from the communication data 219 as the attack detection phase parameter value.

The process value table update unit 208 updates the process value table 214.

In other words, each time the communication data analysis unit 207 extracts the process value 220, the process value table update unit 208 updates the process value table 214 with the extracted process value 220.

The communication data detection unit 209 detects that the communication data 219 (attack detection phase communication data) is acquired by the communication unit 203. Then, the communication data detection unit 209 outputs the process value table 214 to the state estimation unit 212 and instructs the state estimation unit 212 to proceed with state estimation.

The state estimation unit 212 estimates the current operation state (attack detection phase operation state) of the monitored system 500 using the learning model 215 and the process value 220 included in the process value table 214. The process value 220 included in the process value table 214 is the attack detection phase parameter value.

Then, the state estimation unit 212 outputs the estimated operation state to the attack detection unit 213, as an attack detection phase operation state 222.

The attack detection unit 213 detects an attack on the monitored system 500 using the attack detection phase operation state 222, the detection rule 216, and the communication data 219 (attack detection phase communication data).

The result output unit 205 outputs a detection result 217 to the user of the intrusion detection apparatus 200 via the input/output device 905.

The detection result 217 is a determination result of the presence or absence of the attack on the monitored system 500 by the attack detection unit 213.

When the attack detection unit 213 determines that the attack on the monitored system 500 has occurred, the user is notified of the detection of the attack by the detection result 217. When the attack detection unit 213 determines that there is no attack on the monitored system 500, the user is notified that no attack has occurred by the detection result 217.

### ***Description of Operation***

Next, the details of the operation of the intrusion detection apparatus 200 according to the present embodiment will be described.

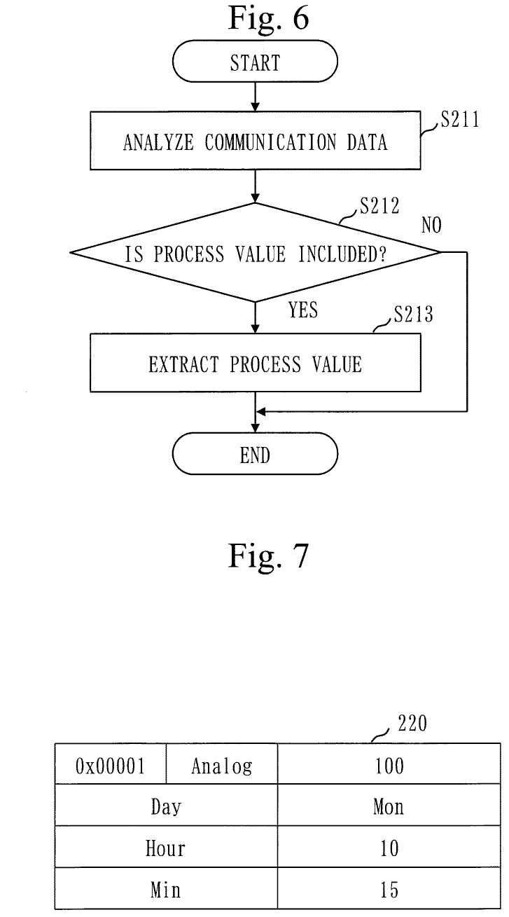

FIG. 6 illustrates an example of operation of the communication data analysis unit 207 in the learning phase.

When the communication unit 203 receives the communication data 219, the communication data analysis unit 207 acquires the communication data 219 from the communication unit 203. Then, the communication data analysis unit 207 analyzes the communication data 219 (step S211).

As a result of the analysis, when the process value 220 is included in the communication data 219 (YES in step S212), the communication data analysis unit 207 extracts the process value 220 from the communication data 219 (step S213).

The communication data analysis unit 207 outputs the extracted process value 220 to the process value table update unit 208.

FIG. 7 illustrates an example of the process values 220 extracted by the communication data analysis unit 207.

In FIG. 7, memory address “0X00001”, data attribute “Analog”, data value “100”, day of week “Day: Mon”, hour “Hour: 10” and minute “Min: 15” are extracted as the process values 220.

The memory address is a memory address at which a data value is to be written or read. The data attribute is one of Analog and Digital. The data attribute “Analog” indicates that the data value is an analog value. The data attribute “Digital” indicates that the data value is a digital value. The data value is a value to be written to the memory address or a value to be read from the memory address. The day of week, the hour, the minute indicate a day of week, an hour, and a minute when the communication data 219 has been sent. The communication data analysis unit 207 may not extract the day of week, the hour and the minute as the process values 220.

The process values 220 exemplified in FIG. 7 are equivalent to learning phase parameter values. The process value 220 extracted by the communication data analysis unit 207 as the learning phase parameter value is not limited to those in FIG. 7. The learning phase parameter value may be a parameter value from which the operation state of the monitored system 500 can be estimated in the attack detection phase. Thereby, the communication data analysis unit 207 can extract a parameter value other than those illustrated in FIG. 7 as the process value 220 (learning phase parameter value).

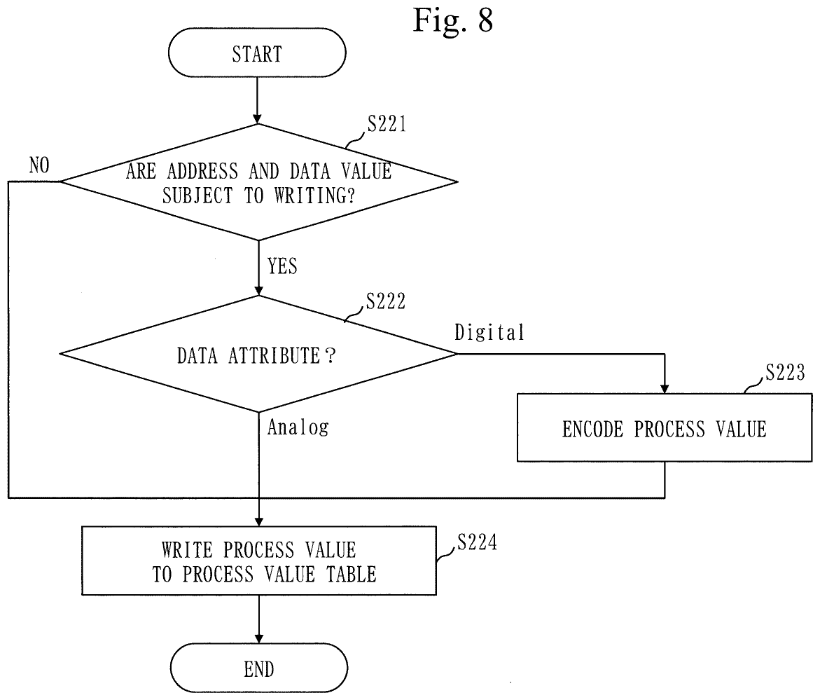

FIG. 8 illustrates an example of operation of the process value table update unit 208 in the learning phase.

The process value table update unit 208 determines whether or not the process value 220 to be written to the process value table 214 is a pair of the memory address and the data value (step S221).

When the process value 220 to be written to the process value table 214 is the pair of the memory address and the data value (YES in step S221), the process proceeds to step S222. On the other hand, when the process value 220 to be written to the process value table 214 is not the pair of the memory address and the data value (NO in step S221), the process proceeds to step S224.

In the example of FIG. 7, when the process value table update unit 208 attempts to write a pair of “0x00001” and “100” to the process value table 214, it is determined as “YES” in step S221. On the other hand, when the process value table update unit 208 attempts to write one of “Mon”, “10”, and “15” to the process value table 214, it is determined as “NO” in step S221.

In step S222, the process value table update unit 208 determines the data attribute of the data value subject to writing.

When the data attribute is “Analog”, the process proceeds to step S224. On the other hand, when the data attribute is “Digital”, the process proceeds to step S223.

Since the data attribute of the data value “100” is “Analog” in the example of FIG. 7, the process proceeds to step S224.

In step S223, the process value table update unit 208 encodes the data value whose data attribute is “Digital” to facilitate machine learning by the learning unit 210. For example, the process value table update unit 208 encodes the data value using one-hot encoding.

In step S224, the process value table update unit 208 writes the process value 220 to the process value table 214.

For the data value whose data attribute is “Digital”, the process value table update unit 208 writes to the process value table 214, the data value encoded in step S223 in association with the memory address.

For the data value whose data attribute is “Analog”, the process value table update unit 208 write to the process value table 214, the data value acquired from the communication data analysis unit 207 in association with the memory address.

When a data value has already been written in the process value table 214 in association with the same memory address, the process value table update unit 208 overwrites the data value with a new data value. For example, it is assumed that the data value “80” is written in the process value table 214 in association with the memory address “0X00001”. In this case, it is assumed that the process value 220 illustrated in FIG. 7 is acquired by the communication unit 203. The process value table update unit 208 rewrites the data value corresponding to the memory address “0X00001” in the process value table 214, from “80” to “100”.

Further, the process value table update unit 208 also writes the day of week (Day), hour (Hour), and minute (Min), to the process value table 214.

Even if the day of week (Day), hour (Hour), and minute (Min) have already been written in the process value table 214, the process value table update unit 208 overwrites the day of week (Day), hour (Hour), and minute (Min) with new values.

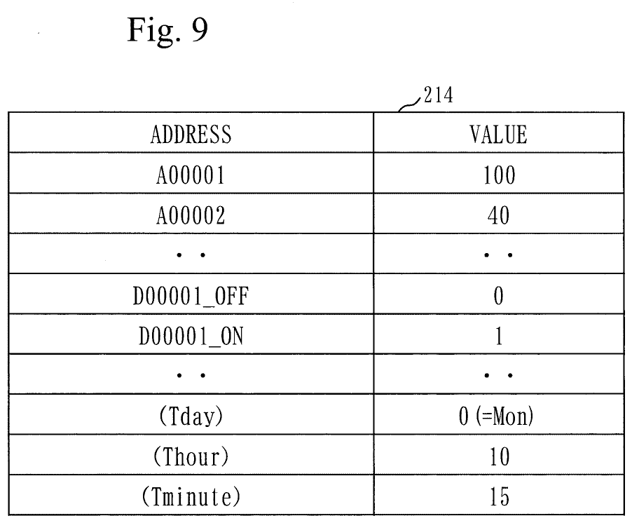

FIG. 9 illustrates an example of the process value table 214.

In FIG. 9, an entry that begins with “A” such as “A00001” means the memory address for analog value. In other words, “A00001” is equivalent to “0X00001” in FIG. 7. An entry that begins with “D” such as “D00001_OFF” means the memory address for digital value. An entry that begins with “T” such as “Tday” means a unit of time. In other words, “Tday” is equivalent to “Day” in FIG. 7. “Thour” is equivalent to “Hour” in FIG. 7. “Tminute” is equivalent to “Min” in FIG. 7.

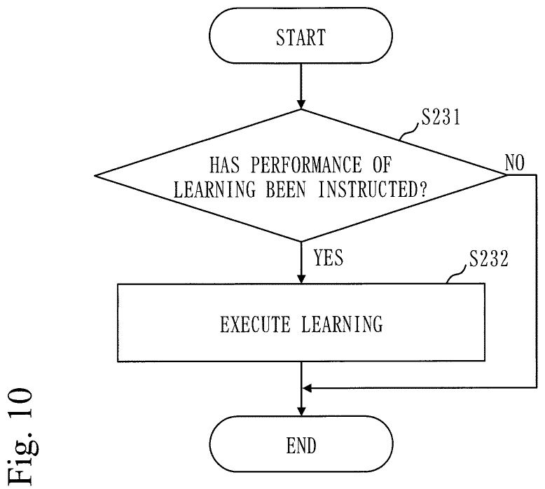

FIG. 10 illustrates an example of operation of the learning unit 210.

First, the learning unit 210 determines whether or not it has been instructed to perform learning from the communication data detection unit 209 (step S231). The learning unit 210 determines that it has been instructed to perform learning from the communication data detection unit 209 when the learning unit 210 has acquired the process value table 214 from the communication data detection unit 209.

When it has been instructed to perform learning from the communication data detection unit 209, the process proceeds to step S232.

In step S232, the learning unit 210 performs learning and generates the learning model 215.

More specifically, the learning unit 210 acquires the learning phase operation state value 221 from the state input unit 204. Then, the learning unit 210 performs learning using the learning phase operation state value 221 and the process value 220 included in the process value table 214 acquired from the communication data detection unit 209.

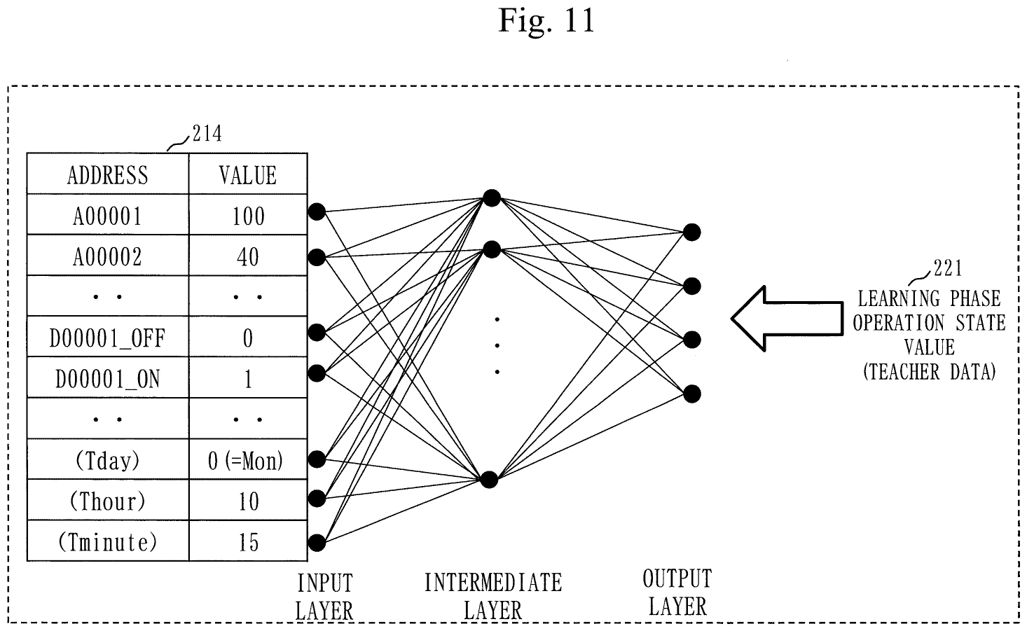

FIG. 11 illustrates an overview of a learning procedure performed in the learning unit 210.

The learning unit 210 uses each process value 220 in the process value table 214 as an input node. Then, the learning unit 210 generates the learning model 215 for state estimation using the learning phase operation state value 221 acquired from the state input unit 204 as a teacher.

FIG. 11 illustrates an example of learning based on a neural network. The learning unit 210 may also perform learning by another learning method (a support vector machine or the like).

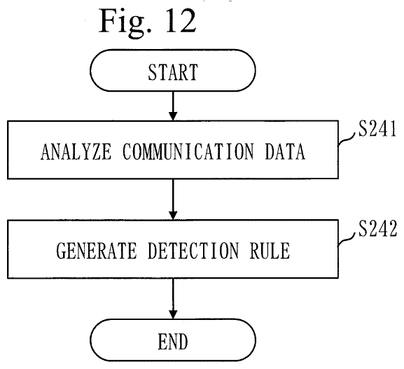

FIG. 12 illustrates an example of operation of the detection rule generation unit 211.

First, the detection rule generation unit 211 acquires the communication data 219 from the communication unit 203 and analyzes the acquired communication data 219 (step S241).

Based on the analysis of the communication data 219, the detection rule generation unit 211 extracts parameter values to be used for the generation of the detection rule 216 from the communication data 219. More specifically, the detection rule generation unit 211 extracts the process value 220 and a specific parameter value other than the process value 220, as the parameter values to be used for the generation of the detection rule 216. For example, the detection rule generation unit 211 extracts a transmission source address of the communication data 219. Further, for example, the detection rule generation unit 211 extracts a transmission destination address of the communication data 219. Furthermore, for example, the detection rule generation unit 211 extracts a control command notified in the communication data 219.

These specific parameter values other than the process value 220, which are extracted by the detection rule generation unit 211, are equivalent to learning phase additional parameter values.

Next, the detection rule generation unit 211 generates the detection rule 216.

More specifically, the detection rule generation unit 211 acquires the learning phase operation state value 221 from the state input unit 204. Then, the detection rule generation unit 211 generates the detection rule 216 using the parameter values extracted in step S241 and the learning phase operation state value 221.

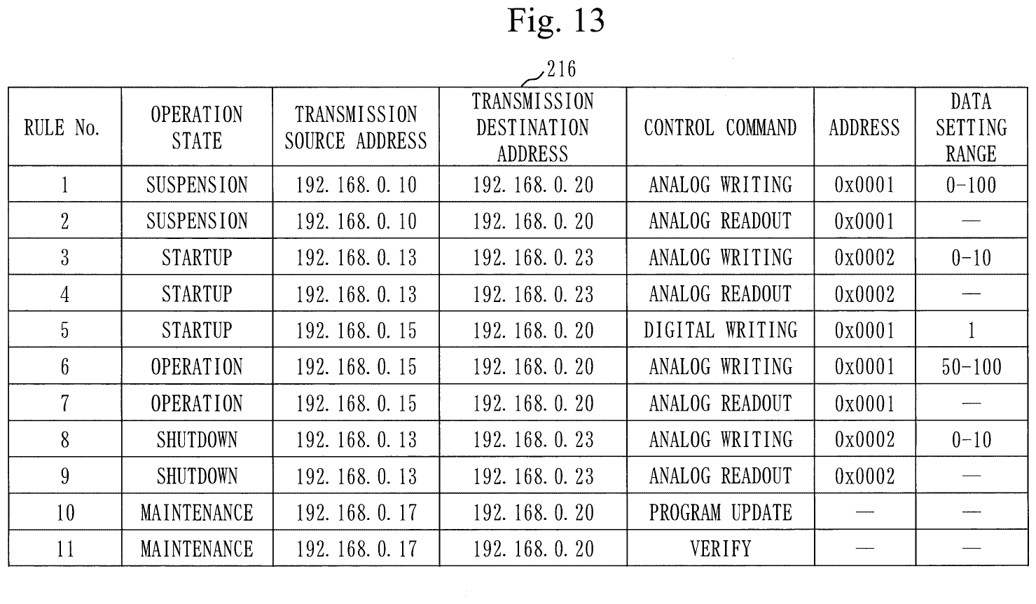

FIG. 13 illustrates an example of the detection rule 216 generated by the detection rule generation unit 211.

In FIG. 13, “Rule No.” indicates the identification number of each rule.

“Operation state” indicates the learning phase operation state. The detection rule generation unit 211 identifies the learning phase operation state from the learning phase operation state value 221.

“Transmission source address” indicates the transmission source address extracted in step S241.

“Transmission destination address” indicates the transmission destination address extracted in step S241.

“Control command” indicate the control command extracted in step S241.

“Address” indicates the memory address extracted in step S241.

“Data setting range” indicates a range of minimum to maximum data values extracted from the communication data 219 so far.

For example, it is assumed that “192.168.0.10” is written as “transmission source address” in the communication data 219 (referred to as latest communication data 219) that includes the process values 220 illustrated in FIG. 7. Further, it is assumed that “192.168.0.20” is written as “transmission destination address” in the latest communication data 219. Further, it is assumed that “analog writing” is written as “control command” in the latest communication data 219. Furthermore, it is assumed that “0-80” is written as “data setting range” of “rule No.1” of the detection rule 216 (FIG. 13) before the reception of the latest communication data 219.

The learning phase operation state value 221 which corresponds to “suspension” is assumed to be acquired as the operation state of the monitored system 500 by the state input unit 204 when the latest communication data 219 is received by the communication unit 203.

In this case, the detection rule generation unit 211 modifies “data setting range” of “rule No.1” from “0-80” to “0-100” to include the data value of the latest communication data 219.

The detection rule 216 may include a value other than those indicated in FIG. 13. For example, the day (Day), hour (Hour), and minute (Min) illustrated in FIG. 7 may also be included in the detection rule 216.

Next, an example of operation of the intrusion detection apparatus 200 in the attack detection phase will be described.

The communication data analysis unit 207 also performs the operation illustrated in FIG. 6 in the attack detection phase.

Further, the process value table update unit 208 also performs the operation illustrated in FIG. 8 in the attack detection phase.

In the attack detection phase, the communication data analysis unit 207 and the process value table update unit 208 handle the attack phase communication data, not the learning phase communication data.

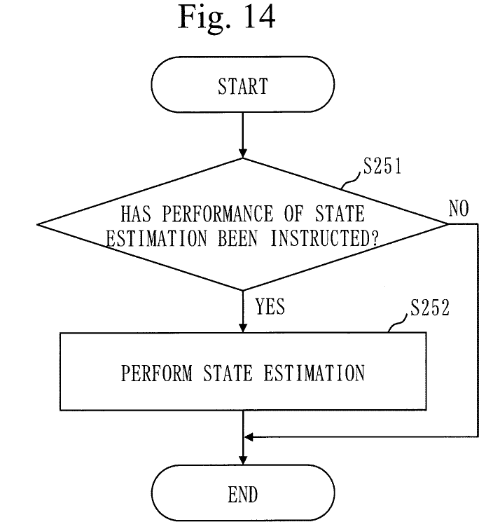

FIG. 14 illustrates an example of operation of the state estimation unit 212.

First, the state estimation unit 212 determines whether or not it has been instructed to perform state estimation by the communication data detection unit 209 (step S251). When the state estimation unit 212 has acquired the process value table 214 from the communication data detection unit 209, the state estimation unit 212 determines that it has been instructed to perform state estimation by the communication data detection unit 209.

When it has been instructed to perform state estimation by the communication data detection unit 209, the process proceeds to step S252.

In step S252, the state estimation unit 212 estimates the current state (the attack detection phase operation state 222) of the monitored system 500.

More specifically, the state estimation unit 212 acquires the learning model 215 from the memory unit 202. Then, the state estimation unit 212 estimates the current state of the monitored system 500 using the learning model 215 and the process value 220 included in the process value table 214 acquired from the communication data detection unit 209.

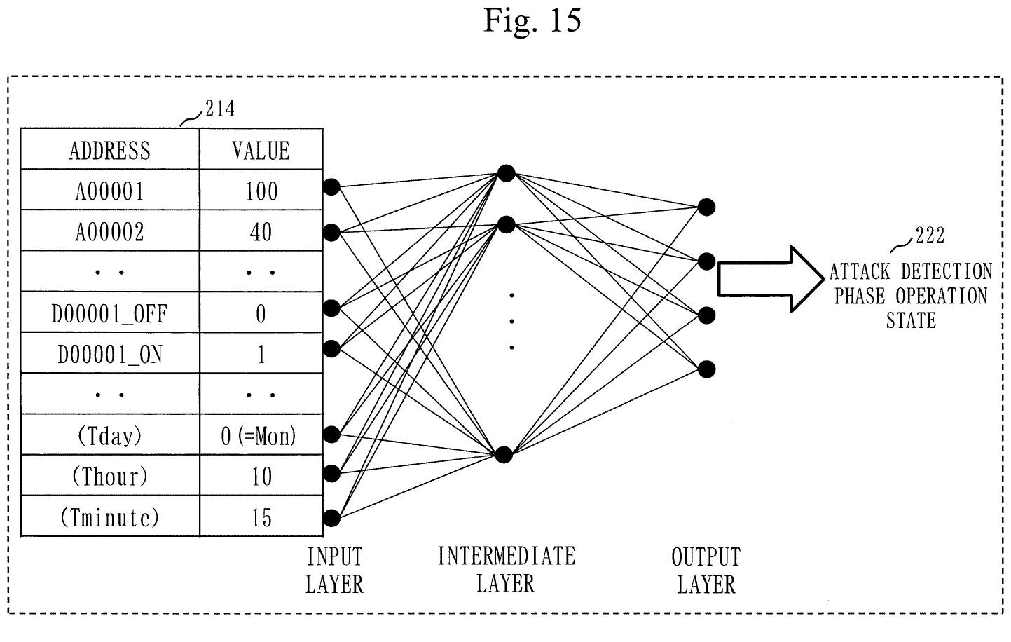

FIG. 15 illustrates an overview of a state estimation procedure performed in the state estimation unit 212.

The state estimation unit 212 uses each process value 220 in the process value table 214 as an input node. Then, the state estimation unit 212 estimates the attack detection phase operation state 222 using the learning model 215.

FIG. 15 illustrates an example of state estimation based on a neural network. The state estimation unit 212 may also perform state estimation by another state estimation method (a support vector machine or the like).

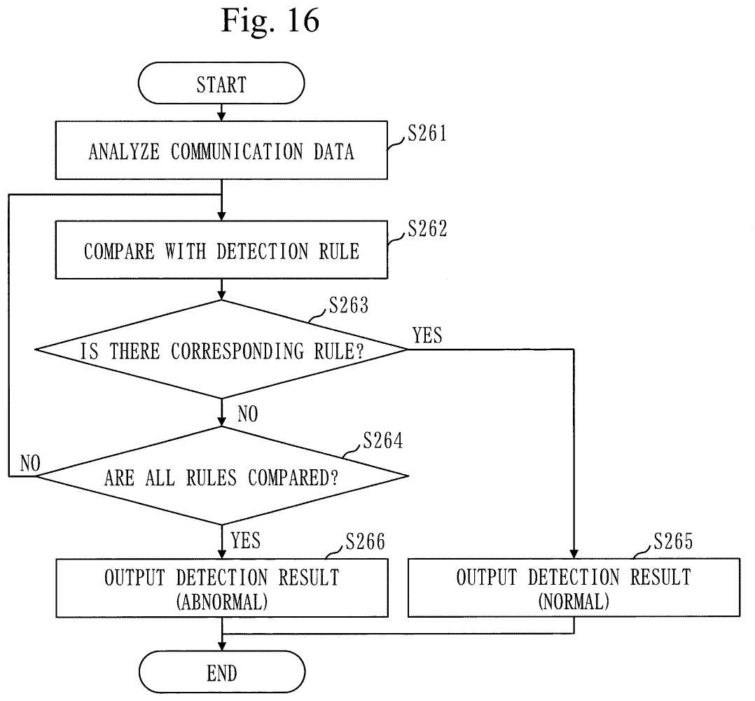

FIG. 16 illustrates an example of operation of the attack detection unit 213.

First, the attack detection unit 213 acquires the communication data 219 (attack phase communication data) from the communication unit 203 and analyzes the acquired communication data 219 (step S261).

Based on the analysis of the communication data 219, the attack detection unit 213 extracts from the communication data 219, a parameter value to be used for comparison with the detection rule 216. More specifically, the attack detection unit 213 extracts the parameter value written in the detection rule 216. In other words, the attack detection unit 213 extracts the transmission source address of the communication data 219. Further, the attack detection unit 213 extracts the transmission destination address of the communication data 219. Further, the attack detection unit 213 extracts the control command notified in the communication data 219. Furthermore, the attack detection unit 213 extracts the memory address and the data value indicated in the communication data 219.

The transmission source address, the transmission destination address, and the control command extracted by the attack detection unit 213 are equivalent to attack detection phase additional parameter values.

Next, the attack detection unit 213 compares the pair of the parameter value extracted in step 261 and the attack detection phase operation state 222 with the pair of the parameter value and the operation state of the detection rule 216. In other words, the attack detection unit 213 determines whether or not there is a rule that describes an operation state matching the attack detection phase operation state 222 and a parameter value matching the parameter value extracted in step 261 is written.

Then, when there is a corresponding rule (YES in step S263), the attack detection unit 213 outputs “detection result (normal)” via the result output unit 205 (step S265).

On the other hand, when there is no corresponding rule (NO in step S263 and Yes in step S264), the attack detection unit 213 outputs “detection result (abnormal)” via the result output unit 205 (step S266).

“Detection result (normal)” is a detection result that notifies the monitored system 500 that no attack has occurred. On the other hand, “detection result (abnormal)” is a detection result that notifies the monitored system 500 that an attack is in progress.

The user can take measures against an attack based on the output of “detection result (abnormal)”.

### ***Description of Effects of Embodiment***

According to the present embodiment, a user does not need to determine an operation state of a monitored system.

Further, according to the present embodiment, the user does not need to input the operation state of the monitored system each time the operation state of the monitored system changes.

Further, according to the present embodiment, it is possible to correctly estimate the operation state of the monitored system, and as a result, it is possible to correctly detect an attack on the monitored system.

### Embodiment 2

In the present embodiment, differences from Embodiment 1 will be mainly described.

Matters not described below are the same as those in Embodiment 1.

### ***Description of Configuration***

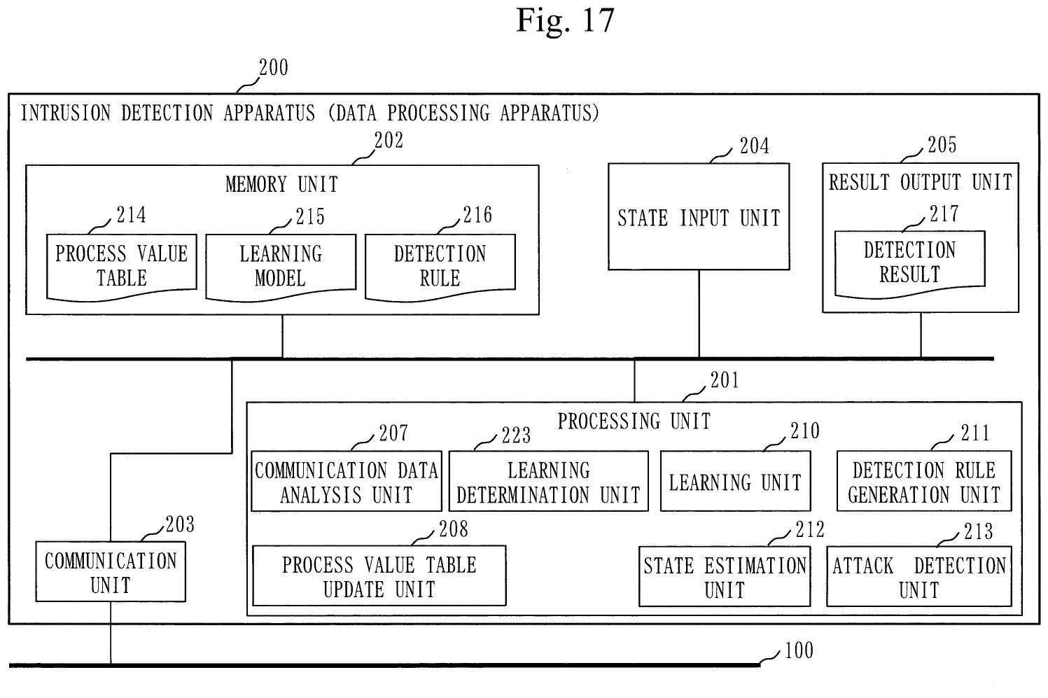

FIG. 17 illustrates an example of a functional configuration of the intrusion detection apparatus 200 according to the present embodiment.

In FIG. 17, there is a learning determination unit 223 instead of the communication data detection unit 209 illustrated in FIG. 3.

The functional components other than the learning determination unit 223 are the same as those illustrated in FIG. 1.

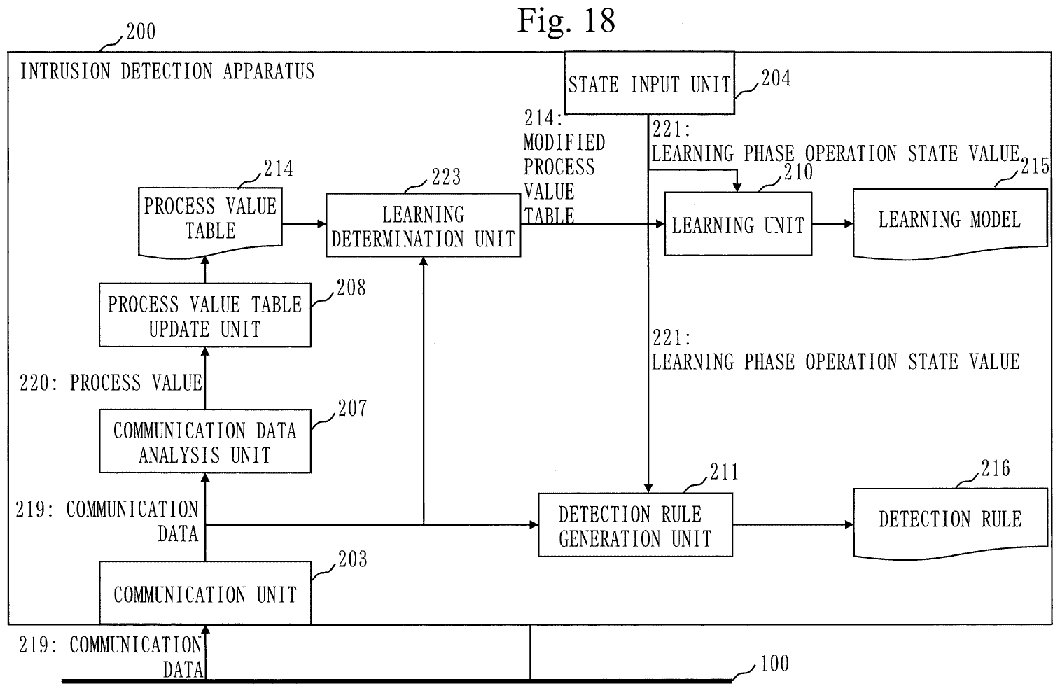

In the present embodiment, as illustrated in FIG. 18, each time the communication unit 203 acquires the communication data 219, the communication unit 203 outputs the acquired communication data 219 to the communication data analysis unit 207, the learning determination unit 223, and the detection rule generation unit 211.

Further, each time the communication data 219 is acquired by the communication unit 203, the communication data analysis unit 207 extracts the process value 220 from the acquired communication data 219, as with Embodiment 1. Then, the communication data analysis unit 207 modifies the process value table 214 using the extracted process value 220. In the present embodiment, the communication data analysis unit 207 does not overwrite the pre-modification process value table 214 with the modified process value table 214. In other words, in the present embodiment, the pre-modification process value table 214 and the modified process value table 214 coexist temporarily.

When the new communication data 219 is acquired by the communication unit 203 and when learning is performed by the learning unit 210 using a process value 220 (referred to as a new process value 220) included in new communication data 219, the learning determination unit 223 determines whether or not a new learning model 215 is generated, which is different from the learning model 215 previously generated by the learning unit 210. Then, only when the learning determination unit 223 determines that the new learning model 215 is generated, the learning determination unit 223 causes the learning unit 210 to perform learning using the new process value 220. In other words, only when the learning determination unit 223 determines that the new learning model 215 is generated, the learning determination unit 223 instructs the learning unit 210 to perform learning using the new process value 220. When the learning determination unit 223 instructs the learning unit 210 to perform learning, the learning determination unit 223 outputs the modified process value table 214 to the learning unit 210.

More specifically, the learning determination unit 223 compares the pre-modification process value table 214 with the modified process value table 214. Then, when there is a difference between the pre-modification process value table 214 and the modified process value table 214, the learning determination unit 223 determines that the new learning model 215 is generated. On the other hand, when there is no difference between the pre-modification process value table 214 and the modified process value table 214, the learning determination unit 223 determines that the new learning model 215 is not generated.

The function of the learning determination unit 223 is implemented by a program as with the communication unit 203 and the like. Then, the program that implements the function of the learning determination unit 223 is executed by the processor 911.

### ***Description of Operation***

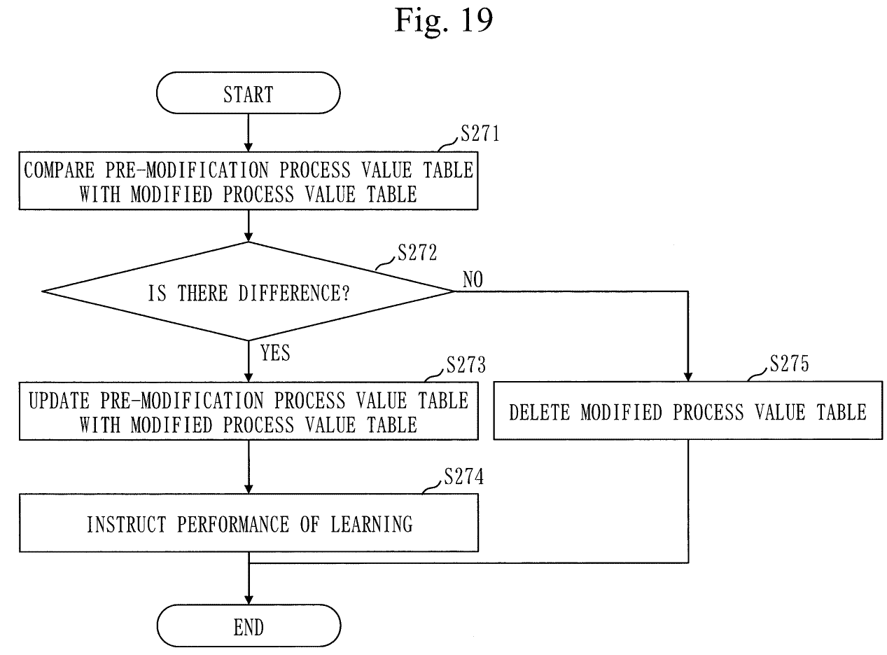

FIG. 19 illustrates an example of operation of the learning determination unit 223.

First, the learning determination unit 223 compares the pre-modification process value table 214 with the modified process value table 214 (step S271).

Then, when there is a difference between the pre-modification process value table 214 and the modified process value table 214 (YES in step S272), the learning determination unit 223 updates the pre-modification process value table 214 with the modified process value table 214. In other words, the pre-modification process value table 214 is deleted from the memory unit 202 and only the modified process value table 214 remains in the memory unit 202.

Then, the learning determination unit 223 outputs the modified process value table 214 to the learning unit 210 and instructs the learning unit 210 to perform learning (step S274). In other words, the learning determination unit 223 instructs the learning unit 210 to perform learning using the new process value 220.

On the other hand, when there is no difference between the pre-modification process value table 214 and the modified process value table 214 (NO in step S272), the pre-modification process value table 214 is deleted from the memory unit 202 (step S275). In other words, the learning determination unit 223 does not instruct the learning unit 210 to perform learning using the new the process value 220.

### ***Description of Effects of Embodiment***

According to the present embodiment, it is possible to eliminate unnecessary learning by not performing learning if no new learning result is obtained.

Embodiments 1 to 2 have been described above and these two embodiments may be implemented in connection.

Alternatively, one of these two embodiments may be implemented partially.

Alternatively, these two embodiments may be implemented partially in connection.

Further, the configurations and procedures described above in these two embodiments may be modified as necessary.

### ***Supplementary Description of Hardware Configuration***

Finally, a supplemental description of the hardware configuration of the intrusion detection apparatus 200 will be given.

The processor 901 illustrated in FIG. 2 is an Integrated Circuit (IC) that performs processing.

The processor 901 is a Central Processing Unit (CPU), a Digital Signal Processor (DSP), or the like.

The main storage device 902 illustrated in FIG. 2 is a Random Access Memory (RAM).

The auxiliary storage device 903 illustrated in FIG. 2 is a Read Only Memory (ROM), a flash memory, a Hard Disk Drive (HDD), or the like.

The communication device 904 illustrated in FIG. 2 is an electronic circuit that executes a communication process for data.

The communication device 904 is, for example, a communication chip or a Network Interface Card (NIC).

Further, the auxiliary storage device 903 also stores an Operating System (OS).

Then, at least a part of the OS is executed by the processor 901.

While executing at least the part of the OS, the processor 901 executes programs that implement the functions of the processing unit 201, the memory unit 202, the communication unit 203, the state input unit 204, and the result output unit 205.

By the processor 901 executing the OS, task management, memory management, file management, communication control, and the like are performed.

Further, at least one of information, data, a signal value, and a variable value that indicate results of processes of the processing unit 201, the memory unit 202, the communication unit 203, the state input unit 204, and the result output unit 205 is stored in at least one of the main storage device 902, the auxiliary storage device 903, and a register and a cache memory in the processor 901.

Further, the programs that implement the functions of the processing unit 201, the memory unit 202, the communication unit 203, the state input unit 204, and the result output unit 205 may be stored in a portable recording medium such as a magnetic disk, a flexible disk, an optical disc, a compact disc, a Blu-ray (registered trademark) disc, or a DVD. Then, the portable recording medium storing the programs that implement the functions of the processing unit 201, the memory unit 202, the communication unit 203, the state input unit 204, and the result output unit 205 may be distributed.

Further, the “unit” of at least one of the processing unit 201, the memory unit 202, the communication unit 203, the state input unit 204, and the result output unit 205 may be read as a “circuit”, “step”, “procedure”, “process”, or “circuitry”.

Further, the intrusion detection apparatus 200 may be implemented by a processing circuit. The processing circuit is, for example, a logic Integrated Circuit (IC), a Gate Array (GA), an Application Specific Integrated Circuit (ASIC), or a Field-Programmable Gate Array (FPGA).

Each of the processing unit 201, the memory unit 202, the communication unit 203, the state input unit 204, and the result output unit 205 is implemented as a part of the processing circuit.

In the present description, a superordinate concept of the processor and the processing circuit is referred to as “processing circuitry”.

That is, each of the processor and the processing circuit is a specific example of the “processing circuitry”.

### REFERENCE SIGNS LIST

100: network; 200: intrusion detection apparatus; 201: processing unit; 202: memory unit; 203: communication unit; 204: state input unit; 205: result output unit; 207: communication data analysis unit; 208: process value table update unit; 209: communication data detection unit; 210: learning unit; 211: detection rule generation unit; 212: state estimation unit; 213: attack detection unit; 214: process value table; 215: learning model; 216: detection rule; 217: detection result; 219: communication data; 220: process value; 221: learning phase operation state value; 222: attack detection phase operation state; 223: learning determination unit; 300: controlled apparatus; 400: control apparatus; 500: monitored system; 901: processor; 902: main storage device; 903: auxiliary storage device; 904: communication device; 905: input/output device.

1. A data processing apparatus comprising:
processing circuitry:
in a learning phase prior to an attack detection phase, to acquire communication data that includes a parameter value from which an operation state of a monitored system can be estimated, and that is to be communicated in the monitored system being monitored for attack detection in the attack detection phase, as learning phase communication data;
in the learning phase, to acquire a learning phase operation state value that indicates a learning phase operation state which is an operation state of the monitored system at a time of communication of the learning phase communication data; in the learning phase, to perform learning using the learning phase operation state value and a learning phase parameter value which is a parameter value included in the learning phase communication data, and to generate a state estimation model for estimating from an attack detection phase parameter value which is a parameter value included in attack detection phase communication data which is communication data that is to be communicated in the monitored system in the attack detection phase, an attack detection phase operation state which is an operation state of the monitored system at a time of communication of the attack detection phase communication data; and
in the learning phase, to generate a detection rule that includes the learning phase parameter value and the learning phase operation state value, and serves for detecting an attack on the monitored system in the attack detection phase by comparing the learning phase parameter value with the attack detection phase parameter value, and by comparing the learning phase operation state indicated by the learning phase operation state value with the attack detection phase operation state.

2. The data processing apparatus according to claim 1, wherein
the learning phase communication data includes a parameter value other than the learning phase parameter value, as a learning phase additional parameter value,
the attack detection phase communication data includes a parameter value corresponding to the learning phase additional parameter value, as an attack detection phase additional parameter value, and
the processing circuitry generates a detection rule that includes the learning phase additional parameter value, and serves for detecting an attack on the monitored system in the attack detection phase by comparing the learning phase additional parameter value with the attack detection phase additional parameter value.

3. The data processing apparatus according to claim 1, wherein
the processing circuitry, in the attack detection phase, acquires the attack detection phase communication data,
the processing circuitry, in the attack detection phase, estimates the attack detection phase operation state using the attack detection phase parameter value and the state estimation model, and
the processing circuitry, in the attack detection phase, detects an attack on the monitored system by comparing the attack detection phase parameter value with the learning phase parameter value which is included in the detection rule, and by comparing the learning phase operation state indicated by the learning phase operation state value included in the detection rule with the estimated attack detection phase operation state.

4. The data processing apparatus according to claim 3, wherein
the learning phase communication data includes a parameter value other than the learning phase parameter value, as a learning phase additional parameter value,
the attack detection phase communication data includes a parameter value corresponding to the learning phase additional parameter value, as an attack detection phase additional parameter value,
the detection rule includes the learning phase additional parameter value, and
the processing circuitry, in the attack detection phase, detects an attack on the monitored system by comparing the learning phase additional parameter value included in the detection rule with the attack detection phase additional parameter value.

5. A data processing method comprising:
in a learning phase prior to an attack detection phase, acquiring communication data that includes a parameter value from which an operation state of a monitored system can be estimated, and that is to be communicated in the monitored system being monitored for attack detection in the attack detection phase, as learning phase communication data;
in the learning phase, acquiring a learning phase operation state value that indicates a learning phase operation state which is an operation state of the monitored system at a time of communication of the learning phase communication data;
in the learning phase, performing learning using the learning phase operation state value and a learning phase parameter value which is a parameter value included in the learning phase communication data, and generating a state estimation model for estimating from an attack detection phase parameter value which is a parameter value included in attack detection phase communication data which is communication data that is to be communicated in the monitored system in the attack detection phase, an attack detection phase operation state which is an operation state of the monitored system at a time of communication of the attack detection phase communication data; and
in the learning phase, generating a detection rule that includes the learning phase parameter value and the learning phase operation state value, and serves for detecting an attack on the monitored system in the attack detection phase by comparing the learning phase parameter value with the attack detection phase parameter value, and by comparing the learning phase operation state indicated by the learning phase operation state value with the attack detection phase operation state.

6. A non-transitory computer readable medium storing a data processing program for causing a computer to execute:
a communication data acquisition process, in a learning phase prior to an attack detection phase, to acquire communication data that includes a parameter value from which an operation state of a monitored system can be estimated, and that is to be communicated in the monitored system being monitored for attack detection in the attack detection phase, as learning phase communication data;
a learning phase operation state value acquisition process, in the learning phase, to acquire a learning phase operation state value that indicates a learning phase operation state which is an operation state of the monitored system at a time of communication of the learning phase communication data;
a model generation process, in the learning phase, to perform learning using the learning phase operation state value and a learning phase parameter value which is a parameter value included in the learning phase communication data, and to generate a state estimation model for estimating from an attack detection phase parameter value which is a parameter value included in attack detection phase communication data which is communication data that is to be communicated in the monitored system in the attack detection phase, an attack detection phase operation state which is an operation state of the monitored system at a time of communication of the attack detection phase communication data; and
a detection rule generation process, in the learning phase, to generate a detection rule that includes the learning phase parameter value and the learning phase operation state value, and serves for detecting an attack on the monitored system in the attack detection phase by comparing the learning phase parameter value with the attack detection phase parameter value, and by comparing the learning phase operation state indicated by the learning phase operation state value with the attack detection phase operation state.
